(19) United States
(12) Patent Application Publication
(10) Pub. No.: US 2025/0171594 A1
(43) Pub. Date: May 29, 2025

(54) METHOD FOR PREPARING A THERMOPLASTIC COMPOSITION

(71) Applicant: UPM-Kymmene Corporation, Helsinki (FI)

(72) Inventors: Janak SAPKOTA, Helsinki (FI); Teemu POHJALAINEN, Helsinki (FI); Matti RISTOLAINEN, Helsinki (FI); Pasi VIRTANEN, Helsinki (FI); Harri KOSONEN, Helsinki (FI); Sakari MODIG, Helsinki (FI)

(21) Appl. No.: 18/842,554

(22) PCT Filed: Feb. 27, 2023
(86) PCT No.: PCT/FI2023/050112

§ 371 Date: Aug. 29, 2024

(30) Foreign Application Priority Data
Mar. 1, 2022 (FI) 20225187

(51) Int. Cl. C08G 81/02; C08L 87/00

(52) U.S. Cl. CPC C08G 81/027; C08L 87/005; C08L 2201/06; C08L 2205/16; C08L 2207/04

(57) ABSTRACT

A method for preparing a thermoplastic composition comprising grafted cellulose and optionally grafted hemicelluloses is disclosed. The method comprises providing a composition comprising cellulose and optionally hemicelluloses; dissolving the cellulose and optionally the hemicelluloses of the composition at least partially, thereby obtaining a solution comprising solubilized cellulose and optionally solubilized hemicelluloses; adding a cyclic ester monomer to the solution, such that the cyclic ester monomer reacts with the solubilized cellulose and optionally the solubilized hemicelluloses, thereby grafting the solubilized cellulose and optionally the solubilized hemicelluloses with the cyclic ester monomer at least partially; and coagulating the grafted cellulose and optionally the grafted hemicelluloses, thereby obtaining the thermoplastic composition.

### TECHNICAL FIELD

The present disclosure relates to a method for preparing a thermoplastic composition, to the thermoplastic composition and to products obtainable therefrom.

### BACKGROUND

Cellulose and hemicelluloses are renewable raw materials well suited for producing thermoplastic materials.

Thermoplastic cellulose and hemicellulose derivatives, which may be processed using conventionally used thermoplastic processing devices, such as extrusion and moulding, are of high interest as an alternative to fossil-based thermoplastic materials. In addition, based on the general considerations on the correlation between molecular structure, degree of substitution and biodegradability, such derivatives may allow both thermoplastic processing and post-consumer waste management via biological decomposition.

However, balancing biodegradability, thermoplasticity and material properties may be challenging.

### SUMMARY

A method for preparing a thermoplastic composition comprising grafted cellulose and optionally grafted hemicelluloses is disclosed. The method may comprise providing a composition comprising cellulose and optionally hemicelluloses; dissolving the cellulose and optionally the hemicelluloses of the composition at least partially, thereby obtaining a solution comprising solubilized cellulose and optionally solubilized hemicelluloses; adding a cyclic ester monomer to the solution, such that the cyclic ester monomer reacts with the solubilized cellulose and optionally the solubilized hemicelluloses, thereby grafting the solubilized cellulose and optionally the solubilized hemicelluloses with the cyclic ester monomer at least partially; and coagulating the grafted cellulose and optionally the grafted hemicelluloses, thereby obtaining the thermoplastic composition.

### BRIEF DESCRIPTION OF THE DRAWINGS

The accompanying drawings, which are included to provide a further understanding of the embodiments and constitute a part of this specification, illustrate various embodiments. In the drawings:

FIG. 1 illustrates an embodiment of the method for preparing a thermoplastic composition.

FIG. 2 shows the Fourier transform infrared spectroscopy (FTIR) spectra of cellulose starting material and the produced caprolactone grafted cellulose.

FIG. 3 shows the biodegradability of lactone grafted cellulose samples with different degrees of substitution. Ref.=reference; MCC=microcrystalline cellulose; 20-02831-007=grafted cellulose with a degree of substitution of 1.72; and 20-02831-012=grafted cellulose with a degree of substitution of 0.61 (Example 1).

### DETAILED DESCRIPTION

A method for preparing a thermoplastic composition is disclosed.

The thermoplastic composition may comprise grafted cellulose and optionally grafted hemicelluloses.

The method may comprise
providing a composition comprising cellulose and optionally hemicelluloses;
dissolving the cellulose and optionally the hemicelluloses of the composition at least partially, thereby obtaining a solution comprising solubilized cellulose and optionally solubilized hemicelluloses;
adding a cyclic ester monomer to the solution, such that the cyclic ester monomer reacts with the solubilized cellulose and optionally the solubilized hemicelluloses, thereby grafting the solubilized cellulose and optionally the solubilized hemicelluloses with the cyclic ester monomer at least partially; and
coagulating the grafted cellulose and optionally the grafted hemicelluloses, thereby obtaining the thermoplastic composition.

Reacting the cyclic ester monomer with the solubilized cellulose and optionally the solubilized hemicelluloses produces solubilized cellulose and optionally solubilized hemicelluloses to which monomers, oligomers and/or polymers of the cyclic ester are grafted. The cyclic ester bonds to OH groups of the hemicelluloses and optionally of the cellulose. Thus the cyclic ester esterifies the cellulose and optionally the hemicelluloses. The reaction may be considered to be a ring-opening polymerization reaction of the cyclic ester monomer.

The grafted cellulose and optionally the grafted hemicelluloses is/are thus polymerisation products of the cellulose and optionally the hemicelluloses and of the cyclic ester monomer.

As the cellulose and optionally the hemicelluloses are solubilized, OH groups thereof may be more accessible, and the cellulose and optionally the hemicelluloses may be grafted more efficiently and homogeneously, as compared e.g. to cellulose and optionally hemicelluloses that are not solubilized but may have a fiber structure.

The cellulose and optionally the hemicelluloses may be grafted with the cyclic ester monomer at least partially in the sense that at least a portion of the cellulose and optionally of the hemicellulose molecules may be grafted.

The cellulose and optionally the hemicelluloses may be grafted with the cyclic ester monomer at least partially such that the monomers, oligomers and/or polymers (polyesters) of the cyclic ester are distributed essentially uniformly or homogeneously within the cellulose and optionally the hemicellulose molecules.

A polyester (such as a polylactone), i.e. a polyester that is not grafted to cellulose or hemicellulose, may be obtained as a side product. The polyester may be removed at least partially, if desired, for example if a certain purity level of the thermoplastic composition is desired. The free acidity content of the thermoplastic composition may be e.g. less than 2% (w/w) as determined by the standard ASTM D871-96. The polyester, such as polylactone, may be removed at least partially by extraction, for example with acetic acid, after the reaction. However, an amount of the polyester may remain in the thermoplastic composition, at least in some embodiments. It may also have a role in the material properties, such as the melting temperature of the thermoplastic composition.

An example of the grafting reaction with ε-caprolactone as the cyclic ester monomer (lactone) is depicted in Scheme 1 below.

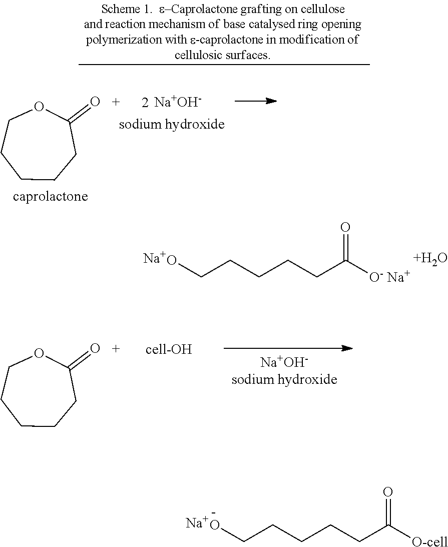

The resulting thermoplastic composition may be biodegradable.

In general, biodegradation and the biodegradability of a polymer material or composition may depend on the environmental conditions and time required for the degradation. For example, environmental conditions may be aggressive or less aggressive. The following environmental conditions may be considered to be in an order of increasing aggressiveness: marine environment, fresh water, waste water treatment plant, soil, home compost, and industrial compost. Biodegradability does not necessarily mean that the product, such as the thermoplastic composition, would be biodegradable in any one of these conditions, or in any one of these conditions in any given time. For example, in less aggressive conditions, biodegradation may require significantly longer periods of time.

The thermoplastic composition may be biodegradable as determined by the standard OECD for testing of chemicals 301 F.

The term “biodegradable” may, at least in some embodiments, refer to readily biodegradable as determined by the standard OECD for testing of chemicals 301 F (Manometric respiratory test). The readily biodegradable thermoplastic composition or thermoplastic polymer material may be a thermoplastic composition or a thermoplastic polymer material for which at least 60% biodegradability is reached within 28 days as determined by the standard OECD for testing of chemicals 301 F.

It may be possible to adjust and/or control to which extent the cellulose and optionally the hemicelluloses are grafted. For example, when the cellulose and optionally the hemicelluloses are solubilized efficiently, they may be grafted relatively uniformly, the resulting thermoplastic composition may have properties different from a thermoplastic composition in which the cellulose and optionally the hemicelluloses that are grafted e.g. only at the surface of fibers.

The extent to which the cellulose and optionally the hemicelluloses are grafted may also affect the barrier properties of the thermoplastic composition. If the hemicelluloses and optionally the cellulose are grafted essentially throughout, then the thermoplastic composition may have better barrier properties than e.g. a thermoplastic composition in which mainly or only the surface of the hemicelluloses and optionally of the cellulose are grafted.

Thus the extent and/or type of grafting may be adjusted and/or controlled depending on the intended purpose, environmental impact, material energy efficiency, and/or other factors. For example, the use of toxic solvents may be minimized; the number of process steps may be minimized; atom economy may be maximized; and/or waste may be minimized.

In the context of this specification, the term “a cyclic ester monomer” or “the cyclic ester monomer” may be understood as referring to one or more cyclic ester monomers, and/or a mixture or combination thereof.

The cyclic ester monomer may comprise or be a lactone or a mixture of one or more lactones.

The cyclic ester monomer may be a lactone selected from lactones represented by formula (I) and/or (II)

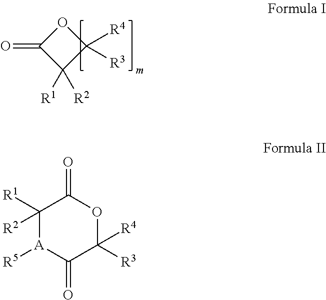

wherein R¹ and R² are each independently selected from the group consisting of H, methyl, ethyl, and propyl;
R³ and R⁴ are each independently selected from the group consisting of H, methyl, ethyl, and propyl;
A is selected from O and N;
R⁵ is selected from the group consisting of H, methyl, ethyl, and propyl when A is N, and R⁵ is absent when A is O; and
m is an integer in the range of 1 to 5.

In an embodiment, in formula I and/or II, one of R¹ and R² is H and the other one of R¹ and R² is selected from the group consisting of H, methyl, ethyl, and propyl;
one of R³ and R⁴ is H and the other one of R³ and R⁴ is selected from the group consisting of H, methyl, ethyl, propyl;
A is selected from O or N;
R⁵ is selected from the group consisting of H, methyl, ethyl, and propyl when A is N and R⁵ is absent when A is O; and
m is an integer in the range of 1 to 5.

In an embodiment, in formula I and/or II, one of R¹ and R² is H and the other one of R¹ and R² is selected from the group consisting of H, methyl, ethyl, and propyl;
one of R³ and R⁴ is H and the other one of R³ and R⁴ is selected from the group consisting of H, methyl, ethyl, propyl;
A is selected from O or N;
R⁵ is H when A is N and R⁵ is absent when A is O; and
m is an integer in the range of 1 to 5.
m may be 1, 2, 3, 4, or 5.

The cyclic ester monomer may be a lactone or any mixture or combination of lactones, such as ε-caprolactone, γ-valerolactone, δ-valerolactone, or any mixture or combination thereof.

The composition comprising the cellulose and optionally the hemicelluloses may be a mixture of cellulose and hemicelluloses. In other words, the cellulose and hemicelluloses may be provided as a mixture comprising cellulose and hemicelluloses. Any references to cellulose and optionally hemicelluloses in this specification may thus also be understood as referring to the mixture comprising cellulose and hemicelluloses.

Such a mixture, and the composition comprising the cellulose and optionally the hemicelluloses, may comprise or be e.g. pulp, such as chemical pulp.

The composition comprising the cellulose and optionally the hemicelluloses, such as pulp, may be alkaline soluble, such as alkaline soluble pulp.

The pulp may comprise or be e.g. wood pulp (such as hardwood and/or softwood pulp), non-wood pulp, and/or agropulp. The pulp may be chemical pulp, such as kraft pulp. The pulp may, additionally or alternatively, be never dried pulp, such as never dried kraft pulp.

Many sources of cellulose may additionally contain an amount of hemicelluloses. For example, pulp may comprise a mixture of cellulose and hemicelluloses. The mixture may comprise e.g. at least 3 wt-%, or at least 5 wt-%, or at least 10 wt-% of hemicelluloses on the basis of the total dry weight of the cellulose and hemicelluloses.

Cellulose is a polysaccharide containing a linear chain of a couple of thousands to ten thousand linked D-glucose units.

Hemicellulose is a heteropolymer, i.e. the term “hemicelluloses” may be understood as referring to a number of heteropolymers (matrix polysaccharides), such as arabinoxylans. Hemicelluloses are present along with cellulose in almost all terrestrial plant cell walls. While cellulose is crystalline, strong, and resistant to hydrolysis, hemicelluloses have a random, amorphous structure with little strength. In other words, the term “hemicelluloses” may be understood as referring to one or more hemicellulose molecules and their mixtures. Hemicelluloses are composed of diverse sugars, and may include xylose, arabinose, glucose, mannose, galactose, and/or rhamnose. Hemicelluloses may contain mainly D-pentose sugars, and optionally small amounts of L-sugars. Xylose is in most cases the sugar monomer present in the largest amount, although in softwoods mannose may be the most abundant sugar. Not only regular sugars can be found in hemicellulose, but also their acidified forms, for instance glucuronic acid and galacturonic acid.

The cellulose may be present as cellulose fibres, macrofibrils and/or microfibrils.

The composition comprising the cellulose and optionally the hemicelluloses may be dissolved in an alkaline solution. The alkaline solution may comprise an alkaline agent, such as NaOH, LiOH, KOH, Mg(OH)₂, Ca(OH)₂, NH₄OH, and/or any mixture or combination thereof. Additional organic hydroxide may also be included in the alkaline solution, such as tetrabutylammonium hydroxide, etc. The alkaline solution may be an aqueous alkaline solution.

The composition comprising the cellulose and optionally the hemicelluloses and the alkaline solution may be mixed, for example by feeding them into a continuous reactor or a high consistency dissolving unit in which partial or full dissolution of the cellulose and optionally the hemicelluloses may be achieved.

The alkaline solution may be an aqueous alkaline solution. For example, the alkaline solution may comprise alkali metal hydroxide (e.g. sodium hydroxide, NaOH) and optionally a zinc salt (e.g. zinc oxide, ZnO). The alkaline solution may comprise the alkaline agent, such as NaOH, at a concentration of about 5-15% (w/w). The alkaline solution may further comprise about 0-3% (w/w), or 0.1-2.5% (w/w) of the zinc salt.

The concentration of the solubilized cellulose and optionally the hemicelluloses in the solution, i.e. in the mixture containing the solubilized cellulose and optionally the solubilized hemicelluloses, may be e.g. about 1-12% (w/w).

The alkaline solution may be a cold alkaline solution. The temperature of the cold alkaline solution may be e.g. in the range of −5° C. to 5° C.

The dissolving of the cellulose and optionally the hemicelluloses of the composition at least partially may be achieved using a method (and/or reagents) that is (are) not sensitive to the presence of hemicelluloses.

The consistency of the solubilized cellulose and optionally the solubilized hemicelluloses, i.e. the mixture containing the solubilized cellulose and optionally the solubilized hemicelluloses, may be adjusted so as to be desirable e.g. for extrusion. The consistency of the solubilized cellulose and optionally the solubilized hemicelluloses, i.e. the mixture containing the solubilized cellulose and optionally the solubilized hemicelluloses, may be e.g. in the range of 5-12% (w/w).

The solubilized cellulose and optionally the solubilized hemicelluloses, i.e. the mixture containing the solubilized cellulose and optionally the solubilized hemicelluloses, may have a viscosity value e.g. in the range of 150 ml/g to 500 ml/g.

The cyclic ester monomer may be added to and/or mixed with the solubilized cellulose and optionally the solubilized hemicelluloses, i.e. the mixture containing the solubilized cellulose and optionally the solubilized hemicelluloses.

The cyclic ester monomer may be reacted with the solubilized cellulose and optionally the solubilized hemicelluloses in the presence of a suitable catalyst.

The cyclic ester monomer may be reacted with the solubilized cellulose and optionally the solubilized hemicelluloses in the presence of a basic catalyst.

Such a basic catalyst may be or comprise, for example, a strong base, such as LiOH, NaOH, KOH, Ca(OH)₂, RbOH, Sr(OH)₂, CsOH, Ba(OH)₂, or any mixture or combination thereof; a superbase catalyst, such as ethoxide ion (C₂H₅ONa), sodium amide (NaNH₂), sodium hydride (NaH), CH₅N₃ (Guanidine), or any mixture of combination thereof; or any mixture or combination thereof.

The alkaline agent of the alkaline solution, such as NaOH, may also function as the basic catalyst. However, an additional basic catalyst may be added in the solution comprising the solubilized cellulose and optionally the solubilized hemicelluloses.

The cyclic ester monomer may be reacted with the solubilized hemicelluloses and optionally the solubilized cellulose at a temperature in the range of about 0-100° C., or in the range of about 0-50° C., or in the range of 1-45° C.

The cyclic ester monomer may be reacted with the solubilized cellulose and optionally the solubilized hemicelluloses for at least 5 minutes, or for at least 30 minutes, or for at least 1 h, or for at least 5 h, or for about 1-5 h, or for about 1-3 h.

The solution comprising the solubilized and/or grafted cellulose and optionally the solubilized and/or grafted hemicelluloses, in particularly when the solution is the alkaline solution, may be considered to be a cellulose spinning solution (cellulose spinning dope).

However, the chemistry used to dissolve the cellulose and optionally the hemicelluloses is not particularly limited, as long as it is possible to solubilize, graft and subsequently coagulate the cellulose and optionally the hemicelluloses into a solid form.

The grafted cellulose and optionally the grafted hemicelluloses may be extruded e.g. through a die or a nozzle.

When the grafted cellulose and optionally the grafted hemicelluloses are coagulated, e.g. by extruding them into a shape, they may be considered to be regenerated. The cellulose is not necessarily actually regenerated cellulose in the sense that it would have undergone the viscose process and subsequent regeneration. In this case, the terms “coagulated” and “regenerated” may refer to cellulose that is precipitated and/or crystallized from the solubilized state; it may be crystallized at least partially into cellulose I; or at least partially into cellulose II; or partially into cellulose I and partially into cellulose II.

The grafted cellulose and optionally the grafted hemicelluloses may be coagulated by extruding and coagulating into fibers or into a shape, such as a filament, a bead, a film, a 3D object, or a molded product. The shape is not particularly limited. Various shapes may be extruded or molded from the grafted cellulose and optionally the grafted hemicelluloses.

The grafted cellulose and optionally the grafted hemicelluloses, e.g. in the form of an extruded shape, such as a filament or any other shape, may be washed after the coagulation and/or extrusion. For example, the method may comprise immersing the grafted cellulose and optionally the grafted hemicelluloses, e.g. the extruded shape, in a washing bath. The washing bath may contain an acidic washing solution, such as a sulphuric acid solution, which then may assist in coagulating the cellulose. The coagulated cellulose and optionally the hemicelluloses, e.g. in the form of the extruded shape, may be immersed in one or more washing baths. For example, after a washing bath containing an acidic washing solution, the coagulated cellulose and optionally the hemicelluloses may be immersed in a second washing bath. Such a second washing bath could comprise e.g. water or another neutral solution.

The thermoplastic composition may thus be in the form of the coagulated cellulose and optionally the hemicelluloses.

However, the thermoplastic composition may, additionally or alternatively, be processed further. The method may further comprise e.g. washing the thermoplastic composition. The method may further comprise e.g. removing unreacted cyclic ester monomer.

The thermoplastic composition may be in the form of the coagulated shape comprising the grafted cellulose and optionally the grafted hemicelluloses. In other words, the shape comprising the grafted cellulose and optionally the grafted hemicelluloses may be the end product that is desired. Alternatively or additionally, it may be processed further. For example, it may be possible to form other shapes or products from the shape comprising the grafted cellulose and optionally the grafted hemicelluloses. Thus the resulting thermoplastic composition comprising the grafted cellulose and optionally the grafted hemicelluloses may be e.g. in the form of pellets or a powder.

The method may further comprise pelletizing (i.e. forming pellets) or forming a powder of the thermoplastic composition. The method may further comprise forming a film, a filament, a melt, and/or a 3D shape of the thermoplastic composition. Such products may be formed e.g. by extrusion, extrusion molding, and/or injection molding. In principle, the thermoplastic composition and the thermoplastic polymer material may be processed further as other thermoplastic materials.

A thermoplastic composition is also disclosed.

Any embodiments and features described above or below may also be understood as relating to the method, to the thermoplastic composition, the thermoplastic polymer material, and/or the article according to one or more embodiments described in this specification.

The thermoplastic composition may be biodegradable.

The thermoplastic composition may comprise cellulose and optionally hemicelluloses grafted with a polyester, such as a polylactone. The grafted polyester chains may be formed of e.g. at least 10 cyclic ester monomers. In other words, the grafted polyester chains may comprise e.g. at least 10 ester groups each. In embodiments in which the cellulose and optionally hemicelluloses are grafted with a polylactone, the grafted polylactone chains may be formed of e.g. at least 10 lactone monomers.

The thermoplastic composition may be obtainable by or obtained by the method according to one or more embodiments described in this specification.

The degree of substitution of the grafted hemicelluloses and optionally the grafted cellulose in the thermoplastic composition may be in the range of 0.1-3.0, or in the range of 0.1-2.0, or in the range of 0.5-1.5.

The melting temperature of the thermoplastic composition may be in the range of 40-200° C., or in the range of 40-180° C., or in the range of 40-160° C.

The lactone content of the thermoplastic composition may be in the range of 5-210, or in the range of 10-100, or in the range of 50-100 (% of pulp weight). In this context, the term “lactone content” may be understood as referring to the (relative) amount of units derived from the lactone in the thermoplastic composition.

The lactone content of the thermoplastic composition may be measured as the total lactone content of the thermoplastic composition. The lactone content may include the lactone(s) (polylactone(s)) grafted into the cellulose and optionally the hemicelluloses (polylactone(s)) only. It may, in some embodiments, include the polymerization products of the lactone(s) alone (polylactones) that are not grafted into the cellulose and optionally the hemicelluloses. Ungrafted polylactone may be at least partially removed from the thermoplastic composition prior to measuring its lactone content.

The cellulose may be present at least partially as cellulose II, i.e. as cellulose having the crystal structure of cellulose II, in the extruded shape, in subsequent forms obtainable from the extruded shape, and/or in the thermoplastic composition. For example, at least 10% (w/w), or 10-100% (w/w) of the cellulose in the thermoplastic composition may have the crystal structure of cellulose II.

The brightness of the thermoplastic composition may be very good. The brightness of the thermoplastic composition may be similar to pulp brightness.

A thermoplastic polymer material comprising or formed of the thermoplastic composition according to one or more embodiments described in this specification is also disclosed.

The thermoplastic polymer material may further comprise a biocomposite and/or a plastic.

An article obtainable from or formed of the thermoplastic composition according to one or more embodiments described in this specification and/or the thermoplastic polymer material according to one or more embodiments described in this specification is also disclosed.

The article may be e.g. a pellet, a powder, a film, a filament, a melt, a 3D shape, a coating, a hotmelt adhesive, a container, a casing, a packaging article, a filmic label, a paper, a medical device, a plastic or composite profile, and/or a 3D printing filament.

The thermoplastic composition, the thermoplastic polymer material, and/or the article may be recyclable. For example, they may be recyclable in a paper and cardboard recycling system, and/or in another recycling system.

The thermoplastic polymer material and/or the article may be biodegradable.

### EXAMPLES

Reference will now be made in detail to various embodiments, an example of which is illustrated in the accompanying drawings.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

For reasons of simplicity, item numbers will be maintained in the following exemplary embodiments in the case of repeating components.

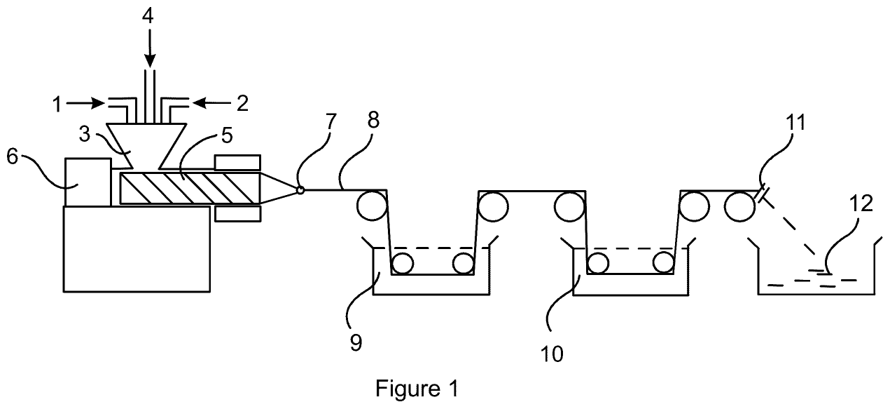

FIG. 1 illustrates an exemplary embodiment of the method. In this embodiment, the method is operated as a semi-continuous process. Alkaline soluble pulp 1 or other suitable composition comprising cellulose and optionally hemicelluloses is mixed with an alkaline solution 2 in a suitable container, such as a reactor 3. The alkaline solution dissolves the pulp, and a solution comprising solubilized cellulose and optionally solubilized hemicelluloses may be obtained.

A cyclic ester monomer 4 is added to the solution. The reactor 3 may provide suitable conditions, such as temperature, for the grafting reaction. After the grafting reaction has taken place, the solubilized mixture comprising the grafted cellulose and optionally hemicelluloses is driven by a screw 5 run by a motor 6 through a die 7. At the die 7, the mixture is extruded into a filament 8; however, the mixture could alternatively be extruded into various other shapes or profiles, such as into a film. The wet filament 8 may then be immersed in a coagulation bath 9 containing e.g. a sulphuric acid solution. In the coagulation bath 9, the grafted cellulose and hemicelluloses that are solubilized in the solution are coagulated. The coagulated filament may then enter a washing bath 10 containing a washing solution, such as water. The filament exiting the washing bath 10 is thus neutralized and washed. the resulting dry thermoplastic composition, i.e. the filament, may be processed e.g. by a pelletizer 11. The resulting pelletized thermoplastic material 12 may then be collected. If desired, it may be e.g. ground into a powder or otherwise processed further.

### Example 1

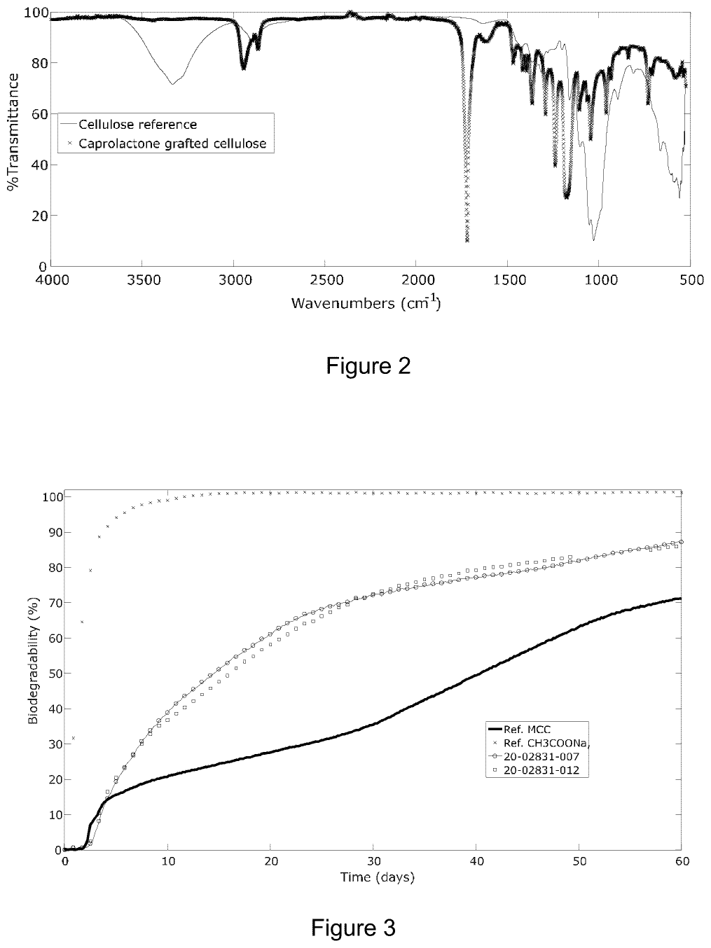

140 g ε-caprolactone and 24 g citric acid as a catalyst were added to Juccheim reactor with mixing set to about 8 Hz. The mixture was let to reflux at 120° C. for 30 minutes to dissolve the citric acid. The reactor was then cooled to 70° C. and 10 g hot cold mixer dried birch pulp was inserted to the reactor. The reaction commenced when the batch reactor temperature was raised to 120° C., and mixing set to 11 Hz. The reactor was held at this temperature for 5 h then worked up as follows: The reactor was first cooled at 40° C., and after cooling 30 g of 20 wt-% NaOH was used to neutralize the citric acid catalyst. Then non-immobilized polycaprolactone and citric acid were extracted from the sample using 300 g acetic acid for about 60 min at 65° C. The product was then filtered from the liquids, slurried with 2 l of deionized water, the procedure being repeated until washings gave a neutral pH suspension. Water was removed as far as possible by filtration and then in an oven at 105° C. The differential scanning calorimetry (DSC) results of the product are shown in Table 1. FTIR spectrum of the product is shown in FIG. 2.

### Example 2

500 g ε-caprolactone and 100 g catalyst citric acid are added to a 3 L high consistency batch reactor with mixing set to about 40 RPM. Mixture is let to reflux at 120° C. for 30 minutes. The reactor is then cooled to 70° C. and 100 g hot cold mixer dried birch pulp is inserted to the reactor.

The reaction commences when the batch reactor temperature is raised to 120° C. The reactor is held at this temperature for 3 h then worked up as follows:

The reactor is first cooled at 60° C. and after cooling 120 g of 20 wt-% NaOH is used to neutralize citric acid catalyst. Then non-immobilized polycaprolactone and citric acid are extracted from the sample using 1.2 kg acetic acid for about 60 min at 65° C. The product is then filtered from the liquids, slurried with 2 l of deionized water, procedure being repeated until washings give neutral pH suspension. Water is removed as far as possible by filtration and then in an oven at 40° C.

### Example 3

40 g of alkaline dope (7.8 wt % NaOH/1.3 wt % Zno/90.9 wt % water) is done by using pretreated softwood kraft pulp (DP abt. 300) with 5% dry matter content.

16 g of ε-caprolactone is added dropwise into the cellulose solution (in 250 ml plastic beaker with overhead stirrer and cooling bath) over 20 min at 0° C. temperature. Cooling bath is prepared for this purpose by making 2 L of 5 wt % NaCl aqueous solution (freezing point −3° C.) and storing this solution in freezer for at least 2 hr before reaction to bring the cooling solution temperature to the desired level.

The mixture is stirred at room temperature for 6 h. Then reactant solution is regenerated with 12% sulfuric acid to give precipitated product. Contents are filtered, washed with water to PH neutral and dried in oven at 40° C.

### Example 4

Caprolactone grafting was performed by reacting caprolactones with birch pulp in laboratory scale using different reactors and catalysts as shown in Table 2. The resulting thermoplastic compositions were found to have varying degrees of substitution and varying melting temperatures.

Table 2 shows reaction parameters and properties of the resulting thermoplastic compositions. The composition indicated as “Homogeneous reaction” was prepared as in Example 3.

The lactone grafted cellulose compositions were moldable with extrusion and injection molding and could be e.g. melt processed.

TABLE 2

| | Birch | | | | | | | |
|---|---|---|---|---|---|---|---|---|
| Reactor | 3L batch reactor | | | | | | | Homogeneous |
| | | | ε-Cpl. | | | Imp. | H/C | reaction |
| Reagent | ε-Cap. | | γ-Val. | | δ-Val. | ε-Cap. | ε-Cap. | ε-Cap. |
| Catalyst | A | B | A | B | A | A | C | C |
| Temperature | 120 | | | | | | | 20 |
| Time (h) | 5 | 3 | 3 | 2 | 3 | 2 | 1 | 6 |
| DS | 0.61 | 1.1 | 0.35 | 0.08 | 1.22 | 0.07 | 0.2 | 0.18 |
| Melt temperature | 48 | 54 | 48 | 143 | 47 | 60 | 230 | 127 |
| (° C.) | | | | | | | | |

DS = Degree of substitution; Melt temperature by DSC = Differential scanning calorimetry
Imp. = Impregnated and oven reaction
A = Citric acid; B = Tartaric acid; C = Base/NaOH
ε-Cpl = ε-caprolactone, γ-Val = γ-valerolactone; and δ-Val = δ-valerolactone

### Example 5

### Biodegradability of Lactone Grafted Cellulose

Lactone grafted cellulose composition samples prepared as above, with different degrees of substitution (DS 1.72 Example 2 and 0.61 Example 1) were tested for their biodegradability using the standard OECD for testing of chemicals 301 (Manometric respiratory test). References used were microcrystalline cellulose (MCC) and CH₃COONa.

The results are shown in FIG. 3. The lactone grafted cellulose composition samples were at least 60% biodegradable within 28 days.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A method, a product, or a use disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A method for preparing a thermoplastic composition comprising grafted cellulose and optionally grafted hemicelluloses, the method comprising:
providing a composition comprising cellulose and optionally hemicelluloses;
dissolving the cellulose and optionally the hemicelluloses of the composition at least partially, thereby obtaining a solution comprising solubilized cellulose and optionally solubilized hemicelluloses;
adding a cyclic ester monomer to the solution, such that the cyclic ester monomer reacts with the solubilized cellulose and optionally the solubilized hemicelluloses, thereby grafting the solubilized cellulose and optionally the solubilized hemicelluloses with the cyclic ester monomer at least partially; and
coagulating the grafted cellulose and optionally the grafted hemicelluloses, thereby obtaining the thermoplastic composition.

2. The method according to claim 1, wherein the thermoplastic composition is biodegradable as determined by the standard OECD for testing of chemicals 301 F.

3. The method according to claim 1, wherein the cyclic ester monomer is a lactone or any mixture or combination of lactones.

4. The method according to claim 1, wherein the cyclic ester monomer is a lactone selected from lactones represented by formula (I) or (II) 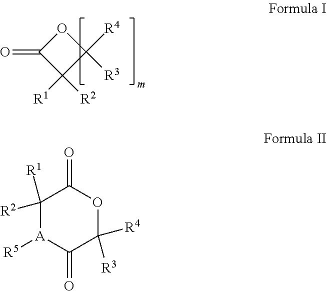
wherein R¹ and R² are each independently selected from the group consisting of H, methyl, ethyl, and propyl;
R³ and R⁴ are each independently selected from the group consisting of H, methyl, ethyl, and propyl;
A is selected from O and N;
R⁵ is selected from the group consisting of H, methyl, ethyl, and propyl when A is N, and R⁵ is absent when A is O; and
m is an integer in the range of 1 to 5.

5. The method according to claim 1, wherein the composition comprising the cellulose and optionally the hemicelluloses comprises or is pulp.

6. The method according to claim 1, wherein the composition comprising the cellulose and optionally the hemicelluloses is dissolved in an alkaline solution.

7. The method according to claim 6, wherein the alkaline solution comprises an alkaline agent.

8. The method according to claim 1, wherein the cyclic ester monomer is reacted with the solubilized cellulose and optionally the solubilized hemicelluloses in the presence of a basic catalyst.

9. The method according to claim 1, wherein the cyclic ester monomer is reacted with the solubilized hemicelluloses and optionally the solubilized cellulose at a temperature in the range of about 0-100° C.

10. The method according to claim 1, wherein the cyclic ester monomer is reacted with the solubilized cellulose and optionally the solubilized hemicelluloses for at least 5 minutes.

11. The method according to claim 1, wherein the solution has a viscosity value in the range of 120-500 ml/g.

12. The method according to claim 1, wherein the grafted cellulose and optionally the grafted hemicelluloses are coagulated by extruding and coagulating them into fibers or into a shape.

13. The method according to claim 1, wherein the method further comprises pelletizing or forming a powder of the thermoplastic composition.

14. A thermoplastic composition, wherein the thermoplastic composition is biodegradable and comprises cellulose and optionally hemicelluloses grafted with a polyester.

15. The thermoplastic composition according to claim 14, wherein the thermoplastic composition is obtainable by a method comprising
providing a composition comprising cellulose and optionally hemicelluloses,
dissolving the cellulose and optionally the hemicelluloses of the composition at least partially, thereby obtaining a solution comprising solubilized cellulose and optionally solubilized hemicelluloses,
adding a cyclic ester monomer to the solution, such that the cyclic ester monomer reacts with the solubilized cellulose and optionally the solubilized hemicelluloses, thereby grafting the solubilized cellulose and optionally the solubilized hemicelluloses with the cyclic ester monomer at least partially, and
coagulating the grafted cellulose and optionally the grafted hemicelluloses, thereby obtaining the thermoplastic composition.

16. The method according to claim 1, wherein the degree of substitution of the grafted hemicelluloses and optionally the grafted cellulose in the thermoplastic composition is in the range of 0.1-3.0.

17. The method according to claim 1, wherein the melting temperature of the thermoplastic composition is in the range of 40-200° C.

18. A thermoplastic polymer material comprising or formed of the thermoplastic composition according to claim 14, wherein the thermoplastic polymer material further comprises a biocomposite and/or a plastic.

19. An article obtainable from or formed of the thermoplastic composition according to claim 14.

20. The article according to claim 19, wherein the article is a pellet, a powder, a film, a filament, a melt, a 3D shape, a coating, a hotmelt adhesive, a container, a casing, a packaging article, a filmic label, a paper, a medical device, a plastic or composite profile, and/or a 3D printing filament.
